(19) United States
(12) Patent Application Publication
(10) Pub. No.: US 2004/0062480 A1
(43) Pub. Date: Apr. 1, 2004

(54) Stable recoated fiber bragg grating

(76) Inventors: Bryon J. Cronk, Round Rock, TX (US); William V. Dower, Austin, TX (US); Diann A. Sloan, Austin, TX (US); Christopher B. Walker JR., Saint Paul, MN (US)

Correspondence Address: 3M INNOVATIVE PROPERTIES COMPANY, PO BOX 33427, ST. PAUL, MN, 55133-3427, US

(21) Appl. No.: 10/255,829

(22) Filed: Sep. 26, 2002

(51) Int. Cl. G02B 6/34

(52) U.S. Cl. 385/37; 385/128

(57) ABSTRACT

A sprayable coating composition for a bare portion of an optical fiber that includes a refractive index grating having a characteristic wavelength response. A coating composition comprises a curable composition having a viscosity from about 0.05 Pa-sec to about 0.30 Pa-sec for spray application to cover the bare portion of the optical fiber, to protect the refractive index grating. A photoinitiator reacts with actinic radiation in the presence of oxygen to cure the curable composition covering the bare portion of the optical fiber. The characteristic wavelength response of the grating exhibits substantially linear variation between a lower limit of temperature and an upper limit of temperature when the curable composition has a glass transition temperature either above the upper limit of temperature or less than about 30° C. above the lower limit of temperature.

### BACKGROUND OF THE INVENTION

1. Field of the Invention

The invention relates to compositions used to coat optical fibers and more particularly to compositions used for recoating bare portions of optical fibers after modifying the bare portions to include periodic variations of refractive index during formation of refractive index gratings that have a characteristic wavelength response exhibiting linear variation between lower and upper limits dependent upon the glass transition temperature of the coating composition.

2. Description of the Related Art

Developments in telecommunications technology have produced a transition from coaxial cables, including copper conductors, to broadband, fiber optic cable networks. Growth factors, affecting the implementation of fiber optic cable systems, include installation costs and the cost for optical components. It is anticipated that further spread of optically based systems, for communication, will require action to lower component pricing. Price-down operations require manufacturing practices for rapid throughput and high yield of products conforming to application specifications.

Optical fiber communication networks use a variety of components for cable interconnection and manipulation of signal carrying light waves. Signal control depends upon special features that may be built into selected, relatively short lengths of optical fibers to be spliced into fiber optic networks. An optical fiber Bragg grating represents a light-modifying feature that may be introduced or written into an optical fiber by exposure to ultraviolet light. Fiber Bragg gratings stabilize the performance of optical systems, particularly lasers, and other parts of the signal injection, amplification and extraction subsystems. To satisfy the requirements of telecommunication systems, for example, Bragg gratings may be applied to control the wavelength of laser light, and to introduce dispersion compensation. For wavelength control, it is necessary for the Bragg grating to be relatively insensitive to temperature change. Fiber optic applications of fiber Bragg gratings, outside of telecommunications, include spectroscopy and remote sensing.

Formation of a Bragg grating in an optical fiber may include a number of steps including removal of protective coatings before introducing periodic changes in refractive index in the core of an optical fiber. Processes for removal of protective buffers and coatings include, for example, mechanical stripping, chemical stripping and thermal stripping. Any of these processes, individually or in combination, may be used to remove radiation-attenuating coatings from an optical fiber to provide an uncoated section of optical fiber. In its uncoated condition, the refractive index of this section of the glass optical fiber may be changed during exposure to radiation from a high intensity ultraviolet laser.

Unless coated, optical fibers are not generally useful due to their susceptibility to damage. Several types of polymeric coatings are known for preventing damage to optical fibers that may occur by physical contact and abrasion or exposure to tensile, torsional, twisting, and bending stresses. Excessive bending can change the optical characteristics of an optical fiber. Polymeric coatings may be selected by a number of criteria including glass transition temperature (Tg) to identify coatings that will protect optical fibers from physical stress including microbending. U.S. Pat. No. 4,682,851 identifies a region of glass transition temperature for a soft, tough optical fiber coating formed by curing compositions including polyurethane, polyamide or polyurea oligomers. Coated glass fibers are used in communication applications. The toughness of the coating is achieved without introducing stiffness, which would cause microbending at low temperature. Japanese Publication JP 2000275482 similarly uses Tg as a basis for selecting a first order coating layer that resists microbending when applied to optical fiber strands of an ocean bed fiber optic cable. International publication WO 2000105724 provides further evidence of the influence of glass transition temperature on optical fiber coatings described as having superior mechanical characteristics.

Coatings for mechanical protection of optical fibers provide recoating compositions for portions of optical fibers from which coatings were removed for formation of Bragg gratings. For the reasons mentioned above, the section of an optical fiber containing a Bragg grating requires application of protective coatings before becoming part of an optical fiber device.

A widely accepted method for recoating bare sections of optical fibers involves special coating molds. A recoating mold, described in U.S. Pat. No. 4,410,561, provides a coated optical fiber using a split mold die structure. The size and design of a cavity formed by the closed mold provides space that becomes filled during injection of curable, protective, fluid recoating compositions. It is desirable to avoid entrapment of air inside the mold since this could lead to a defective recoated fiber section. Complete filling of a mold cavity may involve intentional application of pressure. U.S. Pat. No. 5,022,735 uses a screw type plunger to pressurize recoating fluid injected into a conventional recoating mold. Some recoating molds include curing means to provide finished recoated sections of optical fibers. U.S. Pat. No. 4,662,307, for example, uses a split mold including an injection port and UV light port through which light passes to cure recoating compositions. The curing process requires multiple light sources.

There is evidence in Japanese Patents JP 60-122754 and JP 61-40846 for spraying protective plastic coatings on optical fibers exiting a draw tower. Coverage of the full circumference of the optical fiber requires the uses of either multiple spray heads or special spray containment shrouds. The use of multiple spray heads deposits only a fraction of the spray on the surface of the drawn fiber while the use of special shrouds involves complicated threading of a fiber. U.S. Pat. No. 6,434,314 commonly owned with the present application describes an apparatus and method for spray recoating bare portions of optical fibers after Bragg grating writing.

Recoated fiber Bragg gratings are used in applications requiring predictable behavior of a characteristic wavelength response with temperature. Although Bragg gratings formed in uncoated optical fibers show a substantially linear variation of center wavelength with temperature, this behavior changes and may deviate from a linear response following application of recoat compositions to protect the surface of the optical fiber and the underlying grating. Variation from linearity threatens the reliability of devices that include recoated fiber Bragg gratings. For this reason, there is a need for techniques or material selection criteria that lead to recoated refractive index gratings having a characteristic wavelength exhibiting substantially linear variation between upper and lower temperature limits.

### SUMMARY OF THE INVENTION

The present invention provides compositions used for recoating bare portions of optical fibers after modifying the bare portions to include periodic variations of refractive index, during formation of refractive index gratings. Coating composition selection criteria, according to the present invention, lead to recoated gratings having a characteristic wavelength response that exhibits substantially linear variation between a lower limit of temperature and an upper limit of temperature. This provides improved recoated refractive index or Bragg gratings having a more predictable variation in characteristic wavelength, also referred to herein as the center wavelength, of the grating.

The temperature range for linear behavior of the grating characteristic wavelength appears to depend upon the glass transition temperature (Tg) of the coating composition. When the Tg occurs at a temperature below the operating temperature range for a refractive index or Bragg grating, linear variation of the central wavelength is to be expected. Similarly, if the Tg occurs at a temperature above the operating temperature range of a Bragg grating there will be a linear change in wavelength. In other words, a best-fit plot of wavelength change over the operating temperature range will be a straight line having a constant slope. A different graphical plot occurs if the recoating composition has a glass transition temperature approximately in the middle of the temperature range over which the recoated Bragg grating operates. With this condition, there is a discontinuity in the rate of change of the Bragg grating center wavelength with temperature. The term discontinuity, as used herein, describes a point or region in the graph of center wavelength versus temperature at which there is a noticeable change in the slope of the graph. This reflects an undesirable non-linear region of wavelength change associated with the glassy polymer phase to the rubbery polymer phase transition of the coating composition used to recoat the Bragg grating.

It is known that a bare, uncoated Bragg grating exhibits a substantially linear response within a given range of temperature. Non-linear behavior could, therefore, be attributed to the effect of a coating composition applied to recoat a Bragg grating and cured to support a previously uncoated portion of an optical fiber. The coating has mechanical properties related to Tg, as discussed previously, so that the grating-containing portion of the optical fiber has sufficient protection against abrasion and moisture and other damaging contaminants.

According to the present invention, the Tg of a cured coating has an influence upon variation with temperature of the center wavelength of a fiber Bragg grating. If operation of a Bragg grating is limited to a temperature range above the Tg of the cured coating composition, a predictable variation of center wavelength with temperature can be expected to meet requirements of a straight-line relationship.

Bare portions of optical fibers may be recoated, after refractive index grating formation, using in-mold recoating, spray recoating or an extrusion die coating process. Selection criteria, based upon cured coating Tg, for linear central wavelength variation with temperature may be used with any recoating process. Mold recoating and spray recoating were used for applying coating compositions according to the present invention. Spray recoating provides a non-contact process that may be automated for use in a manufacturing environment to eliminate defects associated with conventional recoating methods. Spray recoating uses multiple passes of an optical fiber between a spray head and a radiation-curing source.

While mold recoating relies upon conventional procedures using a V ytran mold, a spray recoating apparatus according to the present invention comprises at least one recoating spray head and a radiation source. An optical fiber positioner moves the bare portion of an optical fiber between the recoating spray head and the radiation source. Preferably, the position of the recoating spray head is from about 1 cm to about 2 cm from the fiber, preventing contact between the spray head and a deposited coating. The spray recoating method provides controlled sectional recoat that achieves performance characteristics not obtainable from conventional in-mold recoating processes. It is a non-contact method since the optical fiber, including the bare portion, does not touch any part of the recoating equipment. A benefit of spray recoating involves overcoating one recoating composition with another that has different properties. This produces a multilayer buffer structure, around a fiber, including layers that differ in properties such as modulus and durability or hardness that are required for optical fiber protection. As used herein selection of suitable coating compositions requires knowledge of predictive criteria for mechanical protection for the optical fiber while indicating a temperature range in which there is a substantially linear relationship of wavelength with temperature. Although Tg of a cured coating may be used to indicate mechanical properties and wavelength variation with temperature, recoating materials exhibiting desirable wavelength response do not necessarily provide coatings of suitable durability. The converse is also true.

More particularly the present invention provides a coating composition for an optical fiber that has a bare portion including a refractive index grating. The refractive index grating has a characteristic wavelength response. A coating composition according to the present invention comprises a curable composition yielding a cured coating having a measurable glass transition temperature (Tg-onset). The curable composition preferably has a viscosity, before curing, from about 0.05 Pa-sec (50 cp) to about 0.40 Pa-sec (400 cp) for application as a solvent-free composition to cover the bare portion of the optical fiber to protect the refractive index grating. A photoinitiator reacts with actinic radiation, preferably ultraviolet radiation to cure the curable composition covering the bare portion of the optical fiber. The characteristic wavelength response, of the refractive index grating, exhibits substantially linear variation between a lower limit of temperature and an upper limit of temperature. Curable compositions according to the present invention have Tg values that are either less than 30 degrees above the lower limit of temperature or greater than the upper limit of temperature.

The present invention also provides a sprayable coating composition for a bare portion of an optical fiber that includes a refractive index grating that has a characteristic wavelength response. A coating composition comprises a curable composition having a glass transition temperature (Tg-onset) and a viscosity from about 0.04 Pa-sec to about 0.90 Pa-sec for application to cover the bare portion of the optical fiber, to protect the refractive index grating. A photoinitiator reacts with actinic radiation in the presence of oxygen to cure the curable composition covering the bare portion of the optical fiber. The characteristic wavelength response of the grating exhibits substantially linear variation between a lower limit of temperature and an upper limit of temperature when the coating composition has a glass transition temperature less than about 10° C. above the lower limit of temperature.

Terms used herein are defined as follows:

The terms “linear” or “substantially linear” or “linear response” or the like, referring to variation of wavelength with temperature, mean data points of wavelength versus temperature could be described by a straight-line graph.

Terms including “Tg” or “Tg-onset” may be used synonymously herein to describe glass transition temperature.

Unless otherwise stated amounts of materials used herein are in terms of weight %.

### DETAILED DESCRIPTION OF THE PREFERRED EMBODIMENT

Refractive index gratings, also referred to herein as fiber Bragg gratings, may be used in telecommunications applications for stabilizing optical systems by controlling the wavelength of laser light. Optical system stabilization requires that the gratings show little sensitivity to temperature. If change with temperature does occur, preferably there is a predictable relationship between temperature variation and the wavelength of the grating.

Applications requiring predictable behavior of a characteristic wavelength with temperature may use components including recoated fiber Bragg gratings. Although Bragg gratings, formed in uncoated optical fibers, show a substantially linear variation of center wavelength with temperature this behavior changes and may deviate from a linear response following application of recoat compositions to protect the surface of the optical fiber and the underlying grating. Variation from linearity threatens the reliability of devices that include recoated fiber Bragg gratings. For this reason, there is a need for techniques or material selection criteria that lead to recoated refractive index gratings having a characteristic wavelength exhibiting substantially linear variation between upper and lower temperature limits. According to the present invention, the Tg of a cured coating composition affects physical properties of cured coatings. Properties such as coefficient of thermal expansion, coating hardness and transitions between structural phases introduce stress into the grating. If operation of a Bragg grating is limited to a temperature range above the Tg of the coating composition, a predictable linear variation of center wavelength with temperature can be expected. Preferably the linear variation has a slope close to that for the corresponding uncoated fiber Bragg grating.

Curable compositions, suitable for application to optical fibers, include low molecular weight, low viscosity epoxy functional, substantially 100% solids compositions that photocrosslink preferably via an ionic mechanism initiated by a cationic photoinitiator, especially an iodonium salt photoinitiator. Although exceptions exist, curable compositions according to the present invention typically comprise 95 wt % of reactive epoxy monomers and 5 wt % initiator in a small amount of solvent. Such compositions have similar properties to commercial acrylate recoating compositions including good adhesion to the unstripped buffer coats on a fiber as well as to the bare surface of the fiber. Ionic curing occurs without exclusion of oxygen. Suitable epoxy functional curable coating compositions comprise glycidyl epoxy resins, epoxy substituted polybutadienes and cycloaliphatic epoxy resins and the like and mixtures thereof. Epoxy compositions may be cured using photoinitiators including UV 9380C available from General Electric Company, UV 6974 available from Union Carbide Corp. and bis(dodecylphenyl)iodonium tris(trifluoromethylsulfonyl)methide,

Radical curing recoating compositions may also be used in an inert environment that may be readily developed using conventional mold recoating equipment. Materials used for mold recoating typically have viscosities in a range from about 0.5 Pa-sec (500 cp) to about 3.0 Pa-sec (3000 cp). Acrylate coatings for optical fibers, some of which are commercially available, were evaluated using Tg to predict temperature limits between which a fiber Bragg grating would exhibit a substantially linear response of center wavelength versus temperature. The materials tested included acrylate monomers and oligomers including aliphatic urethane acrylates, aromatic urethane acrylates, hexane diol diacrylate, trimethylolpropane triacrylate, ethyl hexyl acrylate and acrylic acid and mixtures thereof. Acrylate-containing curable coatings cure in the presence of radical initiators such as those identified by tradenames IRGACURE™ 220 and DAROCURE 1173, both of which are available from Ciba (Tarrytown, N.Y.).

Suitable radiation sources for photocrosslinking include those having wavelength emission in the blue/visible and ultraviolet wavelength regions of the spectrum. A typical cured recoating composition has an elongation at least equal to and preferably greater than that of glass, i.e. more than 7%. Also, a cured recoating composition has toughness and sufficient adhesion to glass to withstand accidental rubbing or contact with other objects during handling of a recoated fiber. Consideration may be given to other properties of coatings including load bearing coatings, that preferably have a high modulus, and high glass transition temperature (Tg). Some cured coatings exhibit desirable flex and bend characteristics. Preferably coating compositions, in this case, possess properties similar to undisturbed buffer coating originally applied to the fiber.

Any of a number of methods may be used for protective recoating of optical fiber Bragg gratings including in-mold application, extrusion coating and spray coating a bare portion of an optical fiber with a curable liquid coating. Recoating is required to protect the optical fiber from abrasion and surface damaging contaminants, as well as providing at least some support to the recoated optical fiber.

Recoating of optical fibers using mold-recoating techniques has been widely practiced and provides one approach for application of coating compositions according to the present invention. Mold recoating procedures are well known using equipment available from Vytran Corporation of Morganville, N.J. as further described below. Spray coating provides a more convenient and preferred process used herein to investigate changes in Bragg grating center wavelength as a function of glass transition temperature of curable compositions according to the present invention.

The process of recoating a bare portion of an optical fiber may use spray heads based upon either ink jet or ultrasonic atomization technology. Preferably, the application of curable recoating composition, to an optical fiber, uses ultrasonic atomization to provide a non-contact method that dispenses small diameter particles (<50μm, preferably 15μm to 35μm) of a fluid, having a viscosity from about 0.04 Pa-sec to about 0.9 Pa-sec (40 cp to about 900 cp), preferably 0.04 Pa-sec to about 0.4 Pa-sec (40 cp to about 400 cp), over a bare portion of the fiber. Viscosity measurements were made using a TA Instruments AR 200 rheometer employing a temperature sweep from 20° C. to 60° C. Other requirements for a coating composition for recoating optical fibers according to the present invention depend upon the intended use of a recoated optical fiber device such as a Bragg grating used as a light filter.

An ultrasonic atomization process differs from a spray atomization process that requires air velocity to break up a sprayable composition into droplets. Ultrasonic atomization generates volumes of coating composition that are extremely small, in the range from about 0.001 ml/min to about 0.010 ml/min using a 2.0 cc glass syringe available from Popper & Sons. The flow rate for dispensing a substantially non-directional cloud of droplets less than 50 microns in diameter depends upon the speed at which the optical fiber is scanned in front of the atomizer head. A low velocity flow of nitrogen, or other inert carrying gas directs the cloud of ultrafine droplets of recoating composition towards a target surface. The low cloud volume and extremely small droplet size cause the formation of a textured discontinuous covering of the fiber surface. Although coatings are low enough in viscosity for spray application, preferred coating compositions exhibit minimal flow, after application, prior to curing. Flow and droplet agglomeration is further limited because the recoating composition, immediately after application, undergoes exposure to curing radiation from a radiation source. Repeated application of recoating composition builds up a protective coating over a bare portion of an optical fiber. A recoated optical fiber preferably has a relatively smooth, bubble-free appearance. This requirement guides the selection of materials used to prepare recoating compositions according to the present invention.

Experimental
Glossary

| | |
|---|---|
| Material Type | Description/Supplier |

Materials included in Acrylate Coating Compositions

| | |
|---|---|
| Urethane Acrylate | DESOLITE 950-076/Desotech, Elgin IL |
| Urethane Acrylate | DESOLITE 950-106/Desotech, Elgin IL |
| Aliphatic Urethane Acrylate | EBECRYL 230/UBC Radcure, Atlanta GA |
| Aliphatic Difunctional | SR 395/Sartomer, Exton PA |
| Urethane Acrylate | |
| Aromatic Urethane | CN973H85/Sartomer, Exton PA |
| Acrylate | |
| 1,6,Hexanediol Diacrylate | SR 238/Sartomer, Exton PA |
| Trimethylolpropane | SR 351/Sartomer, Exton PA |
| Triacrylate | |
| Acrylic Acid | /Aldrich Chemical Co., Milwaukee WI |
| 2-Ethylhexyl Acrylate | /Aldrich Chemical Co., Milwaukee WI |
| Radical Initiator | IRGACURE 2020/Ciba (Tarrytown, NY) |
| Radical Initiator | DAROCURE 1173/Ciba (Tarrytown, NY) |

Materials used in Epoxy Coating Compositions

| | |
|---|---|
| Epoxy A | CYRACURE UVR-6105/Union |
| | Carbide Corp. |
| Epoxy B | HELOXY 107/Resolution Performance |
| | Prods. |
| Epoxy C | EPONEX 1510/Resolution Performance |
| | Prods. |
| Epoxy D | HELOXY 7/Resolution Performance Prods. |
| Epoxy E | HELOXY 67/Resolution Performance Prods. |
| Epoxy F | POLY BD 600 available from Sartomer Co. |
| Epoxy G | ERYSIS GE 29/CVC Specialty |
| | Chemicals Inc. |
| Epoxy H | Epoxy H is DER 364/Dow Chemicals Inc. |
| Polyether Glycol | TERATHANE 650/E.I. du Pont de Nemours |
| | and Company. |
| Diol | PRIPOL 2033 available from Uniquema |
| Iodonium salt solution 1 | UV 9380C/General Electric Company. |
| Iodonium salt solution 2 | UV 6974/Union Carbide Corp. |
| Iodonium salt solution 3 | 38.5 wt % bis(dodecylphenyl)iodonium |
| | tris(trifluoromethylsulfonyl)methide, |
| | 3.8 wt % isopropylthioxanthone and |
| | 57.7 wt % decyl alcohol. |

Optical Fibers

SMF 28—Available from Corning Inc., Corning, N.Y.

PUREMODE HI 1060 PHOTONIC—Available from Coming Inc., Corning, N.Y.

PANDA 250—Available from Fujikura, Tokyo, Japan

PANDA 1550—Available from Fujikura, Tokyo, Japan

TIGER 14XX—Available from 3M Company, St. Paul, Minn.

TABLE 1
Curable Coating Compositions
Curable Acrylate Coating Formulations

| | Ex- | Ex- | Ex- | Ex- | Ex- |
|---|---|---|---|---|---|
| | ample | ample | ample | ample | ample |
| Material | A1 | A2 | A3 | A4 | A5 |
| Weight % Desolite 950- | 100 | — | — | — | — |
| 076 | | | | | |
| Weight % Desolite 950- | — | 100 | — | — | — |
| 106 | | | | | |
| Weight % Ebecryl 230 | — | — | 65 | 80 | 78 |
| Weight % SR 395 | — | — | 33 | 18 | — |
| Weight % SR 494 | — | — | — | — | 20 |
| Weight % Irgacure 2020 | — | — | 2 | 2 | 2 |

| | Example | Example | Example | Example |
|---|---|---|---|---|
| Material | A6 | A7 | A8 | A9 |
| Weight % Desolite 950- | — | — | — | 90 |
| 200 | | | | |
| Weight % SR 395 | 21.5 | — | — | — |
| Weight % CN973H85 | 76.3 | — | — | — |
| Weight % SR 238 | — | 7 | — | — |
| Weight % SR 351 | — | 7 | 7 | — |
| Weight % AA | — | 12.5 | 14 | 10 |
| Weight % EHA | — | 71.5 | 77 | — |
| Weight % Darocure 1173 | 2.2 | — | — | — |
| Weight % Irgacure 2020 | — | 2 | 2 | — |

### EXAMPLE A10

DSM Desotech offers an optical fiber curable recoating composition identified as DSM 950-200. The viscosity of this material (2.5 Pa-sec at 25° C.) is too high for the spray recoat process. However, it may be coated using standard Vytran mold techniques to recoat bare portions of optical fibers for comparison with other acrylate compositions. This example is also used as a control to compare mold-recoated Bragg gratings with those recoated using the spray recoating process. Mold coated and spray coated samples both show the expected relationship between curable composition Tg and Bragg center wavelength variation with temperature.

TABLE 2
Curable Epoxy Coating Formulations

| | Ex- | Ex- | Ex- | Ex- | Ex- |
|---|---|---|---|---|---|
| | ample | ample | ample | ample | ample |
| Material | E1 | E2 | E3 | E4 | E5 |
| Weight % Epoxy A | 57.0 | 16.2 | — | — | — |
| Weight % Epoxy B | 38.0 | 73.2 | — | | 29.1 |
| Weight % Epoxy C | — | 11 5.7 | 67.0 | 15.1 | — |
| Weight % Epoxy D | — | — | 25.1 | — | — |
| Weight % Epoxy E | — | — | — | 22.9 | 44.6 |
| Weight % Epoxy F | — | — | — | — | 23.3 |
| Weight % Epoxy G | — | — | — | 57.0 | — |
| Weight % Epoxy H | — | — | — | — | — |
| Weight % Polyether | — | — | 2.9 | — | — |
| Glycol | | | | | |
| Weight % Iodonium Salt | 5.0 (1) | 5.0 (1) | 5.0 (1) | 5.0 (2) | 2.94 (1) |
| Solution | | | | | |

| | Example | Example | Example | Example |
|---|---|---|---|---|
| Material | E6 | E7 | E8 | E9 |
| Weight % Epoxy A | — | — | — | — |
| Weight % Epoxy B | 49.4 | 55.9 | — | — |
| Weight % Epoxy C | 26.6 | 23.9 | — | — |
| Weight % Epoxy D | — | | | — |
| Weight % Epoxy E | — | — | 38.0 | 52.3 |
| Weight % Epoxy F | — | — | 34.2 | 23.8 |
| Weight % Epoxy G | — | — | — | — |
| Weight % Epoxy H | 19.0 | 15.2 | — | — |
| Weight % Polyether | — | — | — | — |
| Glycol | | | | |
| Diol 1 | — | — | 22.8 | 19.0 |
| Weight % Iodonium Salt | 4.0 (1) + | 4.2 (1) + | 5.0 (1) | 5.0 (1) |
| Solution | 3.0 (3) | 3.2 (3) | | |

### Coating Preparation

Formulations included in Tables 1 and 2 were mixed until homogeneous and then filtered through a filter capsule into a pre-cleaned brown bottle.

### Measurement of Coating Composition Viscosity

Viscosity measurements were made using a TA Instruments, AR 200 rheometer with a 60 mm, 2° stainless steel cone at a shear stress of 90 Pa employing a temperature sweep from 20° C. to 60° C.

### Tg-Onset Determination Using Dynamic Mechanical Analysis (DMA)

Dynamic Mechanical Analysis is a useful analytical technique that applies an oscillatory load to cured film specimens. The technique provides several types of information including temperature dependent phase changes such as the temperature or region of temperature wherein a given polymer changes from a glassy to a rubbery state.

Spray and mold recoat formulations were cured into films by exposing the liquid composition, placed between polyester films, to multiple passes of ultraviolet irradiation. The exposure unit was a MC-6RQN UV processor (available from Fusion Systems of Rockville Md.) containing a 120 W/cm (300 W/inch) hydrogen bulb at 50 fpm.

Cured rectangular films, having a length of 15 mm, were evaluated using a DMA Model 2980 Dynamic Mechanical Analyzer (available from TA Instruments) operating in a multi-frequency mode. Using a film tension clamp, the conditions of operation included a frequency of 1 Hertz, a strain amplitude of 20 μm, a static force of 0.04 Newtons and a rate of temperature change after equilibration of 2° C./min. Analysis provided values of Tg-onset for the formulations shown in Tables 1 and 2. A graph of storage modulus versus temperature gave evidence of the glassy plateau and the rubbery plateau for each material. Tangent lines, drawn for the glassy plateau, the rubbery plateau and the slope joining the two, provide Tg-onset that is deemed to be the intersection of the tangential lines to the glassy plateau and the sloping region connecting the glassy plateau with the rubbery plateau.

### Thermal Cycling

The rate of change of grating characteristic wavelength with temperature was measured for recoated fiber Bragg gratings using a Thermotron thermal chamber (Thermotron Industries, Holland Mich.). During the test procedure the ends of the Bragg grating-containing optical fiber were connected to monitoring equipment that followed changes in the wavelength of the grating. Initially the temperature in the chamber was decreased to −45° C. for a dwell time of at least five minutes. After measurement of the center wavelength of the grating, at this temperature, the temperature of the chamber was increased and wavelength checked at increments of 5° C. to a maximum temperature of 85° C. Results are reported from tests conducted over a temperature range of −40° C. to +85° C.

### Mold Recoating Process

Mold recoating is a common process using equipment supplied by Vytran Corporation of Morganville, N.J. The equipment includes a mold also referred to as a split mold, each portion of which contains a matching semicircular groove to accommodate an uncoated portion of an optical fiber. The grooves, when clamped together, form a cylindrical bore slightly larger than the outer diameter of coated portions of the optical fiber. This permits air to escape during injection of the coating material. The original coating in this arrangement keeps the uncoated section suspended in the bore. A short uncoated length of fiber, typically no longer than half an inch, minimizes the possibility of damage through contact with the bore. Also, a series of clamps, attached on either side of a central fiber portion, prevent the uncoated portion from touching the bore. Before injecting recoating fluid, the upper half of the mold is clamped in position to form the cylindrical bore. Mold recoating was used for relatively high viscosity acrylate compositions (0.5 Pa-sec to 3.0 Pa-sec) that cure in an inert atmosphere either at elevated temperature or in response to suitable radiant energy such as ultraviolet radiation.

### Evaluation of Coatings on PANDA 250 Optical Fiber

TABLE 3
Wavelength (1480 nm) Variation with Temperature
on PANDA 250 Fiber

| | Appli- | | | |
|---|---|---|---|---|
| | cation | | Temperature | Wavelength |
| Example | Method | Tg-onset | Range | change rate |
| Bare Fiber | None | — | −40° C. to +85° C. | 0.0091 nm/° C. |
| A1 | mold | −9.5° C. | −20° C. to +85° C. | 0.0123 nm/° C. |
| A2 | mold | −57.0° C. | −40° C. to +85° C. | 0.0097 nm/° C. |
| A3 | mold | −54.2° C. | −40° C. to +85° C. | 0.0097 nm/° C. |
| A4 | mold | −52.3° C. | −40° C. to +85° C. | 0.0095 nm/° C. |
| A5 | mold | −52.5° C. | −40° C. to +85° C. | 0.0095 nm/° C. |
| A9 | mold | 13.7° C. | +15° C. to +85° C. | 0.0109 nm/° C. |
| A10 | mold | +2.6° C. | −7° C. to +85° C. | 0.0104 nm/° C. |

Table 3 provides the results of thermal cycling of fiber Bragg gratings coated with acrylate coating compositions applied using the mold recoating technique. Examples A2-A5 exhibit Tg-onset values below the lower limit of the temperature range over which the test was conducted. All of these coating show a substantially linear wavelength versus temperature response over the temperature range tested. It is noticeable that the rate of change of wavelength in each of these cases is close to that of the bare PANDA 250 optical fiber. Higher Tg-onset values, as in A1, A9 and A10, move the lower temperature limit of the linear response range to temperatures above −40° C. Examples A1 and A10 show that the lower temperature limit of the linear response range may be as much as about 10° C. below the Tg value of the cured coating.

### Evaluation of Coatings on PUREMODE HI 1060 PHOTONIC Optical Fiber

TABLE 4
Wavelength (1480 nm) Variation with Temperature on
PUREMODE HI 1060 PHOTONIC Fiber

| | Appli- | | | |
|---|---|---|---|---|
| | cation | | Temperature | Wavelength |
| Example | Method | Tg-onset | Range | change rate |
| Bare Fiber | None | — | −40° C. to +85° C. | 0.0061 nm/° C. |
| A6 | mold | −40° C. | −40° C. to +85° C. | 0.0060 nm/° C. |
| A7 | mold | −30° C. | −25° C. to +85° C. | 0.0063 nm/° C. |
| A8 | mold | −35° C. | −25° C. to +85° C. | 0.0060 nm/° C. |

Table 4 provides the results of thermal cycling of fiber Bragg gratings coated with acrylate coating compositions after writing a Bragg grating into a PUREMODE HI 1060 PHOTONIC optical fiber. Example A6 exhibits a Tg-onset value at the lower limit of the temperature range over which the test was conducted. This coating show a substantially linear wavelength versus temperature response over the temperature range tested. The rate of change of wavelength for each of Examples 6-8 is close to that of the bare PUREMODE HI 1060 PHOTONIC optical fiber. As with earlier examples, higher Tg-onset values, as in A7 and A8, move the lower temperature limit of the linear response range to temperatures above −-40° C. Review of Tables 3 and 4 show that the rate of wavelength change for bare PANDA 250 optical fiber differs from that of bare shows that of bare PUREMODE HI 1060 PHOTONIC optical fiber. This indicates that the type of optical fiber influences how the Bragg center wavelength varies with temperature.

### Spray Recoating Process

A spray head that included an ultrasonic atomizer was used to apply curable recoating formulations, shown in Table 1, to the bare surfaces of several types of silica fiber, each having a diameter of about 125 microns. Each curable coating formulation was dispensed after becoming atomized by absorbing energy from the tip of the atomizing horn of an ultrasonic atomizer available from Sono-Tek. The power supply of the ultrasonic atomizer was set to a level of 5.4 watts. Successful atomization of recoating formulations, having viscosities in the range from about 0.04 Pa-sec (40 cp) to about 0.4 Pa-sec (400 cp) was achieved using a micro-bore fluid delivery tube through the center of the nozzle body of the ultrasonic atomizer. Most preferably the coating composition has a viscosity of about 0.2 Pa-sec (200 cp). Temperature control of the ultrasonic head provides consistent coating viscosity. Recoating formulations were supplied to the micro-bore tube at a syringe pump delivery rate of 0.015 ml/min. A preferred method uses a 21.5 gauge micro-bore tube available from Small Parts Inc., Miami, Fla. This provides precise control of small volumes of recoating composition delivered to the point of atomization.

Ultrasonic atomization as described previously produces a non-directional mist of coating composition that needs to be entrained in a directional gas stream. Preferably the directional gas stream comprises an inert gas, e.g. nitrogen gas, under the control of a shroud around the micro-bore tube. A nitrogen gas stream flowing through the shroud around the atomizer head at a rate of 1.0 liter/min yields a suitably controlled atomized mist of recoating formulation. Adjustment of the air shroud alters the contours of the gas stream thereby modifying the size, shape and coverage of a stream of droplets of curable recoating formulation impinging on a selected surface. A continuous coating may be formed on a surface using as few as about 4 to about 6 applications of a coating formulation.

The ultrasonic system from Sono-tek Corporation coupled with a high output UV Rocket Spot Cure System from Lesco Incorporated provided components for a coating delivery/cure process for recoating bare portions of optical fibers with cured coating. A linear robot was used to position a suspended optical fiber about 1.5 cms in front of the atomized coating and cure station. The robot could be programmed for translation speed, position and duration. One or more ultrasonic spray heads may be used to coat around the circumference of an optical fiber. Use of only one ultrasonic head requires rotation of the optical fiber to cover the entire surface of the bare portion of the optical fiber. As the bare portion of a fiber traverses the location of the recoating spray head, one side of the bare fiber portion receives a light deposit of droplets from a mist of a curable recoating composition. Movement of the robot then places the deposit of droplets in the illumination path of the radiation source. The radiation cures the layer of recoating composition. Returning to the location of the recoating spray head, the robot places another portion of bare fiber in the path of the spray. This allows application of a fine mist of recoating composition to the exposed optical fiber surface. This layer may be cured as described previously. Repeated processing by coating and curing protects the fiber with multiple layers of recoating composition. The recoated fiber surface has a matte appearance resulting from the build up of successive layers of coating material.

Approximately fifty applications of recoating composition followed by curing, after each pass, provide a layer having a thickness over the recoated length similar to that of the original buffer coatings on other parts of an optical fiber. However, depending upon process conditions, application of coating formulation may need to be repeated from about 40 to about 60 times to build a coating thickness of up to 250μm on a selected surface. Additions of up to about 100 applications of curable coating provide coating thickness to about 300 μm. It will be appreciated that application of multiple layers of coating composition requires a significant amount of time. For curable compositions according to the present invention a cycle time of twenty minutes, to recoat a bare portion of an optical fiber, would be acceptable. This goal has been achieved and further reduced to about five minutes per optical fiber.

Spray recoating allows layers of recoating composition to be applied to the surface of an optical fiber to build a protective recoat having a thickness of from about 10 microns to about 100 microns on a bare fiber. The diameters of spray-recoated optical fibers may be measured using a microscope and a QUADRA-CHEK 2000, from Metronics Inc., Bedford, N.H. Coating thickness may be varied depending on the application.

Any number of spray heads, positioned strategically, may be used in a fiber recoating process. Placement of a spray head and radiation source on both sides of an optical fiber facilitates recoating of both sides of the bare fiber portion, while eliminating the need to reposition the optical fiber to completely cover the bare portion containing a Bragg grating. The use of additional radiation sources is optional since the beam from a single radiation source may be reflected to effect curing around the circumference of a recoated fiber.

Tables 5-8 include results providing a relationship between Tg-onset and the temperature range wherein the center wavelength of a Bragg grating shows linear change with temperature.

### Evaluation of Coatings on SMF 28 Optical Fiber

TABLE 5
Wavelength (1480 nm) Variation with
Temperature on SMF 28 Fiber

| | Appli- | | | |
|---|---|---|---|---|
| | cation | | | Wavelength |
| Example | Method | Tg-onset | Temperature Range | change rate |
| E3 | spray | −4.8° C. | −12° C. to +85° C. | 0.0077 nm/° C. |
| E4 | spray | +20.3° C. | −5° C. to +85° C. | 0.0077 nm/° C. |

Table 5 shows the effect of recoating a fiber Bragg grating having a center wavelength of 1480 nm, using coatings, identified in Table 2 as Example E3 and Example E4, applied to SMF 28 fiber.

TABLE 6
Wavelength (1480 nm) Variation with Temperature
on TIGER 14XX Fiber

| | Appli- | | | |
|---|---|---|---|---|
| | cation | | Temperature | Wavelength |
| Example | Method | Tg-onset | Range | change rate |
| E3 | spray | −4.8° C. | −8° C. to +85° C. | 0.0108 nm/° C. |
| E4 | spray | +20.3° C. | +2° C. to +85° C. | 0.0108 nm/° C. |
| E8 | spray | −31.4° C. | −40° C. to +85° C. | 0.0094 nm/° C. |
| E9 | spray | −29.8° C. | −37° C. to +85° C. | 0.0109 nm/° C. |

Table 6 shows the effect of recoating a fiber Bragg grating having a center wavelength of 1480 nm, using coatings, identified in Table 2 as Examples E3,E4,E8 and E9, applied to TIGER 14XX fiber.

TABLE 7
Wavelength (1480 nm) Variation with Temperature
on PANDA 1550 Fiber

| | Appli- | | | |
|---|---|---|---|---|
| | cation | | Temperature | Wavelength |
| Example | Method | Tg-onset | Range | change rate |
| Bare Fiber | None | — | −40° C. to +85° C. | 0.0092 nm/° C. |
| E3 | spray | −4.8° C. | −7° C. to +85° C. | 0.0095 nm/° C. |
| A10 | mold | +2.6° C. | −7° C. to +85° C. | 0.0104 nm/° C. |

Table 7 shows linear variation of Bragg grating wavelength with temperature for a bare PANDA 1550 optical fiber containing a Bragg grating having a center wavelength of 1480 nm. This is compared with a grating sprayed coated using Example E3 of Table 2 and a grating coated in a Vytran mold using the control composition of Example A10. The recoated gratings have a narrower range in which variation of wavelength with temperature is linear. However, since there is less than 10° C. difference between the values of Tg-onset for Example E3 and Example A10, regardless of the coating method, the linear response range is substantially the same.

TABLE 8
Wavelength (980 nm) Variation with Temperature on
PUREMODE HI 1060 PHOTONIC Fiber

| | Appli- | | | |
|---|---|---|---|---|
| | cation | | Temperature | Wavelength |
| Example | Method | Tg-onset | Range | change rate |
| Bare Fiber | None | — | −40° C. to +85° C. | 0.0061 nm/° C. |
| E1 | spray | +109° C. | −40° C. to +85° C. | 0.0161 nm/° C. |
| E2 | spray | +54° C. | +29.5° C. to +85° C. | 0.0075 nm/° C. |
| E4 | spray | +20.3° C. | +7° C. to +85° C. | 0.0064 nm/° C. |
| E9 | spray | −29.8° C. | −37° C. to +85° C. | 0.0063 nm/° C. |
| A10 | mold | +2.6° C. | +1.5° C. to +85° C. | 0.0065 nm/° C. |

Table 8 shows linear variation of Bragg grating wavelength with temperature for a bare Coming PUREMODE HI 1060 PHOTONIC optical fiber containing a Bragg grating having a center wavelength of 980 nm. This is compared with a grating sprayed coated using Examples E1,E2,E4 and E9 of Table 2 and a grating coated in a Vytran mold using the control composition of Example A10. The uncoated grating and the grating coated with a high Tg-onset coating composition of Example E1 exhibit a linear response of Bragg center wavelength over the full temperature range of −40° C. to +85° C. In the other cases (Examples E2, E4, E9 and A10) it is clear that Tg-onset influences the lower limit of the temperature range over which wavelength changes in a linear fashion.

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

What is claimed is:

1. A coating composition for an optical fiber that includes a refractive index grating in a bare portion thereof, said refractive index grating having a characteristic wavelength response, said coating composition comprising:
a curable composition yielding a cured composition having a glass transition temperature (Tg-onset), said curable composition applied to cover said bare portion to protect said refractive index grating; and
a photoinitiator reacting to actinic radiation to cure said curable composition to said cured composition covering said bare portion, said characteristic wavelength response exhibiting substantially linear variation between a lower limit of temperature and an upper limit of temperature.

2. The coating composition of claim 1, wherein said Tg-onset of said cured composition is above said upper limit of temperature.

3. The coating composition of claim 1, wherein said Tg-onset of said cured composition is no more than 30° C. above said lower limit of temperature.

4. The coating composition of claim 3, wherein said Tg-onset of said cured composition is no more than 10° C. above said lower limit of temperature.

5. The coating composition of claim 1, wherein said lower limit of temperature is −40° C. and said upper limit of temperature is +85° C.

6. The coating composition of claim 5, wherein said Tg-onset of said curable composition is greater than about 100° C.

7. The coating composition of claim 1, wherein said curable composition is a solvent-free curable composition.

8. The coating composition of claim 1, wherein said curable composition includes at least one reactive epoxy group.

9. The coating composition of claim 8, wherein said at least one reactive epoxy group is selected from the group consisting of epoxidized polybutadiene, cycloaliphatic epoxy and glycidyl epoxy groups and mixtures thereof.

10. The coating composition of claim 1, wherein said photoinitiator is a cationic photoinitiator.

11. The coating composition of claim 10, wherein said cationic photoinitiator comprises 38.5 wt % bis(dodecylphenyl)iodonium tris(trifluoromethylsulfonyl)methide, 3.8 wt % isopropylthioxanthone and 57.7 wt % decyl alcohol.

12. The coating composition of claim 1, wherein said curable composition includes at least one reactive acrylate group.

13. The coating composition of claim 12, wherein said at least one reactive acrylate group is selected from the group consisting of aliphatic urethane acrylates, aromatic urethane acrylates, hexane diol diacrylate, trimethylolpropane triacrylate, ethyl hexyl acrylate and acrylic acid and mixtures thereof.

14. The coating composition of claim 1, wherein said curable composition has a viscosity, before curing, from about 0.04 Pa-sec to about 3.0 Pa-sec.

15. A sprayable coating composition for an optical fiber that includes a refractive index grating in a bare portion thereof, said refractive index grating having a characteristic wavelength response, said coating composition comprising:
a curable composition including at least one reactive epoxy group and having a glass transition temperature (Tg-onset) after curing to a cured composition, said curable composition further having a viscosity, before curing, from about 0.04 Pa-sec to about 0.90 Pa-sec for application as a solvent-free composition to cover said bare portion to protect said refractive index grating; and
a cationic photoinitiator reacting to actinic radiation in the presence of oxygen to cure said curable composition to said cured composition covering said bare portion, said characteristic wavelength response exhibiting substantially linear variation between a lower limit of temperature and an upper limit of temperature, said Tg-onset having a value less than 30° C. above said lower limit of temperature.

16. The sprayable composition of claim 15, wherein said lower limit of temperature is −40° C. and said upper limit of temperature is +85° C.

17. The sprayable composition of claim 16, wherein said Tg-onset of said cured composition is greater than about 100° C.

18. The sprayable composition of claim 15, wherein said Tg-onset of said cured composition is less than 10° C. above said lower limit of temperature.

19. The sprayable composition of claim 15, wherein said curable composition is a solvent-free curable composition.

20. The sprayable composition of claim 15, wherein said viscosity, before curing is from about 0.04 Pa-sec to about 0.4 Pa-sec.

21. A coated optical fiber including a Bragg grating having a characteristic wavelength exhibiting substantially linear variation between a lower limit of temperature and an upper limit of temperature said coated optical fiber including a cured coating having a glass transition temperature (Tg-onset) no more than 30° C. above said lower limit of temperature.

22. The coated optical fiber of claim 21, wherein said cured coating forms by curing a curable composition including at least one reactive substituent selected from the group consisting of acrylate substituents and epoxy substituents.

23. The coated optical fiber of claim 22, wherein said acrylate substituents are selected from the group consisting of aliphatic urethane acrylates, aromatic urethane acrylates, hexane diol diacrylate, trimethylolpropane triacrylate, ethyl hexyl acrylate and acrylic acid and mixtures thereof.

24. The coated optical fiber of claim 22, wherein said epoxy substituents are selected from the group consisting of epoxidized polybutadiene, cycloaliphatic epoxy and glycidyl epoxy groups and mixtures thereof.

25. The coated optical fiber of claim 22, wherein said curable composition has a viscosity from about 0.04 Pa-sec to about 3.0 Pa-sec.
